(19) United States
(12) Patent Application Publication
(10) Pub. No.: US 2007/0249513 A1
(43) Pub. Date: Oct. 25, 2007

(54) Solid particulate laundry detergent composition comprising aesthetic particle

(76) Inventors: Paul R. Mort, Cincinnati, OH (US); Nigel Patrick Somerville Roberts, Newcastle (GB); Christopher Charles Graham, Ellington (GB); Julie Ellis, Newcastle upon Tyne (GB); John Peter Eric Muller, Newcastle upon Tyne (GB); Saul Nicholas Algar, Stocksfield (GB)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/788,098

(22) Filed: Apr. 19, 2007

Related U.S. Application Data
(60) Provisional application No. 60/793,352, filed on Apr. 20, 2006.

(51) Int. Cl. C11D 17/00

(52) U.S. Cl. 510/445

(57) ABSTRACT

The present invention relates to a solid particulate laundry detergent composition comprising: (a) from 0.1 wt % to 50 wt % of aesthetic particle; and (b) to 100 wt % of the remainder of the solid particulate laundry detergent composition, wherein the ratio of the median particle size in micrometers of the aesthetic particle (D50_{bead}) to the median particle size in micrometers of the remainder of the solid particulate laundry detergent composition (D50_{base}) is greater than 2.0:1, and wherein the relative jamming onset of the aesthetic particle (RJO_{bead}) is less than 9.0.

### CROSS REFERENCES TO RELATED APPLICATIONS

This application claims priority under 37 U.S.C. § 119(e) to U.S. Provisional Application Ser. No. 60/793,352 filed Apr. 20, 2006.

### FIELD OF THE INVENTION

The present invention relates to a solid particulate laundry detergent composition comprising aesthetic particle. The aesthetic particle is visually distinct from the remainder of the composition and does not readily segregate during handling, transport and storage.

### BACKGROUND OF THE INVENTION

Consumers like, and tend to buy, laundry detergent powders that comprise colored speckles. For this reason, laundry detergent manufactures incorporate aesthetic particles that are visually distinct from the remainder of the detergent powder into their particulate laundry detergent compositions. The larger the aesthetic particle, in comparison to the remainder of the detergent powder, the greater the consumer preference; for this reason, laundry detergent manufacturers seek to incorporate the largest colored speckles possible into their detergent powder products. However, problems such as poor flowability and segregation occur when the incorporated speckles become too large.

EP6048142 relates to the production of layered and rounded agglomerates having allegedly a good flowability profile.

### SUMMARY OF THE INVENTION

The present invention provides a solid particulate laundry detergent composition as defined in Claim 1. The Inventors have found that large aesthetic particles can be incorporated into a solid particulate laundry detergent composition that still retains a good flowability profile and avoids the problem of segregation by carefully controlling the physical properties of the aesthetic particle in relation to the remainder of the solid particulate laundry detergent composition.

### DETAILED DESCRIPTION OF THE INVENTION

### Solid Particulate Laundry Detergent Composition

The solid particulate laundry detergent composition comprises: (a) from 0.1 wt % to 50 wt %, preferably from 0.5 wt %, or from 1 wt % or from 2 wt %, and preferably to 40 w %, or to 30 wt %, or to 20 wt %, or to 10 wt %, or to 8 wt %, or to 5 wt % aesthetic particle; and (b) to 100 wt % of the remainder of the solid particulate laundry detergent composition. The aesthetic particles and the remainder of the solid particulate laundry detergent composition are described in more detail below.

The solid particulate laundry detergent composition preferably has a relative jamming onset (RJO_{product} of from 8 to 50, preferably from 10 to 30, and preferably from 12 to 20.

The solid particulate laundry detergent composition preferably has a segregation index (SI) of less than 6.0, preferably less than 5.0, or less than 4.0, or less than 3.0, or less than 2.0, or even less than 1.5, and preferably from 0.01, or from 0.1. Most preferably, the solid particulate laundry detergent composition has a segregation index (SI) of from 0.01 to 4.0. The segregation index is described in more detail below.

### Aesthetic Particle

The aesthetic particle is typically visually distinct from the remainder of the solid particulate laundry detergent composition, for example by using a color, reflective layer, or other aesthetic treatment. Preferably, the aesthetic particle is coloured. Preferably, the aesthetic particle is substantially spherical. By substantially spherical it is typically meant that the aesthetic particle is substantially equi-axed, such as preferably having a median aspect ratio of from 1.0 to 1.2, or even from 1.0 to 1.1.

The aesthetic particles preferably comprise a core and an outer layer. The core preferably has a diameter of at least 300 micrometers, preferably at least 1,000 micrometers. Typically the core comprises a salt, typically an inorganic salt such as sodium sulphate. The core may comprise organic material, such as alkylpolyglycoside. The core may comprise a detergent adjunct material, typically selected from surfactants, builders, perfume, polymers, fabric softening components, enzymes, bleach and mixtures thereof. The layer typically comprises fine particulate material, typically having a diameter of less than 30 micrometers. Preferably the ratio of the diameter of the core in micrometers to the diameter of the fine particulate material comprised by the core is greater than 10:1. Typically, the fine particulate material comprised by the layer adheres to the core via an interaction, preferably by hydration, solidification or neutralization, with a liquid binder. Typically, the liquid binder comprises acid surfactant precursor, such as alkyl benzene sulphonic acid/or sodium silicate.

Preferably, the aesthetic particle has a bulk density (ρ_{bead}) in the range of from 600 g/l to 1,500 g/l. The method of measuring the bulk density is described in more detail below.

Preferably, the aesthetic particle has a median particle size (D50_{bead}) in the range of from 800 micrometers to 4,000 micrometers.

Preferably, the aesthetic particle has a relative jamming onset (RJO_{bead}) is less than 9.0, preferably less than 8.0, or less than 7.0, or less than 6.0, preferably in the range of from 2.0 to 8.0, or from 3.0 to 7.0, or from 4.0 to 6.0. The method of measuring the relative jamming onset is described in more detail below.

### Remainder of the Solid Particulate Laundry Detergent Composition

The remainder of the solid particulate laundry detergent composition typically comprises particles that comprise one or more of the following detergent ingredients: detersive surfactants such as anionic detersive surfactants, nonionic detersive surfactants, cationic detersive surfactants, zwitterionic detersive surfactants, amphoteric detersive surfactants; preferred anionic detersive surfactants are linear or branched C₈₋₂₄ alkyl benzene sulphonates, preferably linear C₁₀₋₁₃ alkyl benzene sulphonates, other preferred anionic detersive surfactants are alkoxylated anionic detersive surfactants such as linear or branched, substituted or unsubstituted C₁₂₋₁₈ alkyl alkoxylated sulphate having an average degree of alkoxylation of from 1 to 30, preferably from 1 to 10, more preferably a linear or branched, substituted or unsubstituted C₁₂₋₁₈ alkyl ethoxylated sulphate having an average degree of ethoxylation of from 1 to 10, most preferably a linear unsubstituted C₁₂₋₁₈ alkyl ethoxylated sulphate having an average degree of ethoxylation of from 3 to 7, other preferred anionic detersive surfactants are alkyl sulphates, alkyl sulphonates, alkyl phosphates, alkyl phosphonates, alkyl carboxylates or any mixture thereof; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; sources of carbonate, preferably carbonate salts such as sodium carbonate and/or sodium bicarbonate; zeolite builders such as zeolite A and/or zeolite MAP, phosphate builders such as sodium tripolyphosphate; carboxylate polymers such as the co-polymer of maleic acid and acrylic acid; silicate salt such as sodium silicate; and mixtures thereof.

Preferably, the remainder of the solid particulate laundry detergent composition has a bulk density (ρ_{base}) in the range of from 200 g/l to 1,500 g/l.

Preferably, the remainder of the solid particulate laundry detergent composition has a median particle size (D50_{base}) in the range of from 300 micrometers to 800 micrometers.

Preferably, the remainder of the solid particulate laundry detergent composition has a relative jamming onset (RJO_{base}) in the range of from 10 to 60. The method of measuring the relative jamming onset is described in more detail below.

### Segregation Index (SI)

The segregation index (SI)=(RJO_{bead}/V_{base})×ln(ρ_{bead}/ρ_{base})−ln(D50_{bead}×AR50_{bead}/D50_{base})|.

RJO_{bead} is the relative jamming onset of the aesthetic particle. The relative jamming onset is described in more detail below.

V_{base} is the volume fraction of the remainder of the solid particulate laundry detergent composition and=1.0−V_{bead}. V_{bead} is the volume fraction of the aesthetic particle. The volume fraction is described in more detail below.

ρ_{bead} is the bulk density in g/l of the aesthetic particle. ρ_{base} is the bulk density in g/l of the remainder of the solid particulate laundry detergent composition. The bulk density is described in more detail below.

D50_{bead} is the median particle size in micrometers of the aesthetic particle. D50_{base} is the median particle size in micrometers of the remainder of the solid particulate laundry detergent composition. The median particle size is described in more detail below.

AR50_{bead} is the median aspect ratio of the aesthetic particle. The median aspect ratio is described in more detail below.

### Relative Jamming Onset

The relative jamming onset is measured using a Flodex™ instrument supplied by Hanson Research Corporation, Chatsworth, Calif., USA. As used in this test method the term “Hopper” refers to the Cylinder Assembly of the Flodex™ instrument; the term “orifice” refers to the hole in the center of the Flow Disk that is used in a flow test; the symbol “B” refers to the diameter of the orifice in the Flow Disk used in the test; and the symbol “b” refers to the dimensionless orifice size, as defined by the ratio of the orifice diameter to the 30^{th} percentile particle size (D₃₀) specified in Applicant's Test Method titled “Flowable Particle Mass Based Cumulative Particle Size Distribution Test”, b=B/D₃₀.

The Flodex™ instrument is operated in accordance with the instructions contained in the Flodex™ operation manual version 21-101-000 rev. C 2004-03 with the following exceptions:

(a) The suitable container that is used to collect the material that is tested is tared on a balance with 0.01 gram precision before the start of the test, and used subsequently to measure the mass of particulate discharge from the Hopper in step (c), below.

(b) Sample preparation. A bulk sample of particles is suitably riffled to provide a sub-sample of 150 ml loose-fill volume. The appropriate sample mass can be determined by measuring the loose fill density specified in the test method titled “bulk density test” described below, and then multiplying by the target volume (150 ml). The mass of the sample (sample mass) is recorded before the start of each test measurement. As the test is non destructive, the same sample may be used repeatedly. The entire sample must be discharged, e.g., by inverting the hopper, and then re-loaded before each measurement.

(c) Starting with the smallest orifice size (typically 4 mm unless a smaller orifice is necessary), three repeat measurements are taken for each orifice size. For each measurement, the sample is loaded into the Hopper and allowed to rest for a rest interval of about 30 seconds before the orifice is opened according to the procedure described in the Flodex™ Operation Manual. The sample is allowed to discharge into the tared container for a period of at least 60 seconds. After this 60 second period and once the flow stops and remains stopped for 30 seconds (i.e., no more than 0.1 mass % of the material is discharged over the 30 second stop interval), then the mass of discharged material is measured, the orifice is closed and the Hopper is fully emptied by inverting the Hopper assembly or removing the flow disk. Note: if the flow stops and then re-starts during the 30 second stop interval, then the stop interval clock must be re-started at zero at the next flow stoppage. For each measurement, the mass % discharged is calculated according to the formula: (mass % discharged)=100*(mass discharged)/(sample mass). The average of the three mass % discharged measurements is plotted as a function of the dimensionless orifice size (b=B/D₃₀), with the mass % discharged on the ordinate and the dimensionless orifice size on the abscissa. This procedure is repeated using incrementally larger orifice sizes until the hopper discharges without jamming for three consecutive times, as per the description of a “positive result” in the Flodex™ Operation Manual.

(d) The plotted data are then linearly interpolated to find the Relative Jamming Onset (RJO), which is defined as the value of the dimensionless orifice size at the point of 25 mass % average discharge. This is determined by the abscissa value (b) at the point where the interpolation is equal to 25 mass % discharge. If the average mass % discharge exceeds 25% for the starting orifice, then flow disks with smaller orifices must be obtained and the test repeated starting with the smaller orifice. Flow disks with smaller orifices such as 3.5, 3.0, 2.5 or even 2.0 mm can be obtained as custom parts from Hanson Research Corporation.

### Bulk Density

The bulk density is typically measured by the following “bulk density test” method:
Summary: A 500 ml graduated cylinder is filled with a powder, the weight of the sample is measured and the bulk density of the powder is calculated in g/l.
Equipment:
1. Balance. The balance has a sensitivity of 0.5 g.
2. Graduated cylinder. The graduated cylinder has a capacity 500 ml. The cylinder should be calibrated at the 500 ml mark, by using 500 g of water at 20° C. The cylinder is cut off at the 500 ml mark and ground smooth.
3. Funnel. The funnel is cylindrical cone, and has a top opening of 110 mm diameter, a bottom opening of 40 mm diameter, and sides having a slope of 76.4° to the horizontal.
4. Spatula. The spatula is a flat metal piece having of a length of at least 1.5 times the diameter of the graduated cylinder.
5. Beaker. The beaker has a capacity of 600 ml.
6. Tray. The tray is either a metal or plastic square, is smooth and level, and has a side length of at least 2 times the diameter of the graduated cylinder.
7. Ring stand.
8. Ring clamp.
9. Metal gate. The metal gate is a smooth circular disk having a diameter of at least greater than the diameter of the bottom opening of the funnel.
Conditions: The procedure is carried out indoors at conditions of 20° C. temperature, 1×10⁵ Nm⁻² pressure and a relative humidity of 25%.
Procedure:
1. Weigh the graduated cylinder to the nearest 0.5 g using the balance. Place the graduated cylinder in the tray so that it is horizontal with the opening facing upwards.
2. Support the funnel on a ring clamp, which is then fixed to a ring stand such that the top of the funnel is horizontal and rigidly in position. Adjust the height of the funnel so that its bottom position is 38 mm above the top centre of the graduated cylinder.
3. Support the metal gate so as to form an air-tight closure of the bottom opening of the funnel.
4. Completely fill the beaker with a 24 hour old powder sample and pour the powder sample into the top opening of the funnel from a height of 2 cm above the top of the funnel.
5. Allow the powder sample to remain in the funnel for 10 seconds, and then quickly and completely remove the metal gate so as to open the bottom opening of the funnel and allow the powder sample to fall into the graduated cylinder such that it completely fills the graduated cylinder and forms an overtop. Other than the flow of the powder sample, no other external force, such as tapping, moving, touching, shaking, etc, is applied to the graduated cylinder. This is to minimize any further compaction of the powder sample.
6. Allow the powder sample to remain in the graduated cylinder for 10 seconds, and then carefully remove the overtop using the flat edge of the spatula so that the graduated cylinder is exactly full. Other than carefully removing the overtop, no other external force, such as tapping, moving, touching, shaking, etc, is applied to the graduated cylinder. This is to minimize any further compaction of the powder sample.
7. Immediately and carefully transfer the graduated cylinder to the balance without spilling any powder sample. Determine the weight of the graduated cylinder and its powder sample content to the nearest 0.5 g.
8. Calculate the weight of the powder sample in the graduated cylinder by subtracting the weight of the graduated cylinder measured in step 1 from the weight of the graduated cylinder and its powder sample content measured in step 7.
9. Immediately repeat steps 1 to 8 with two other replica powder samples.
10. Determine the mean weight of all three powder samples.
11. Determine the bulk density of the powder sample in g/l by multiplying the mean weight calculated in step 10 by 2.0.

### Volume Fraction

The volume fraction is calculated based on the mass in wt % and the bulk density. The volume fraction of the aesthetic particle (V_{bead})=(ρ_{base}×M_{bead})/[(ρ_{base}×M_{bead})+(ρ_{bead}×M_{base})]. The volume fraction of the remainder of the solid particulate laundry detergent composition (V_{base})=(ρ_{bead}×M_{base})/[(ρ_{bead}×M_{base})+(ρ_{base}×M_{bead})], wherein M_{bead} is the amount in wt % of the aesthetic particle, and wherein M_{base} is the amount in wt % of the remainder of the solid particulate laundry detergent composition. M_{bead}+M_{base}=1.0.

### Median Particle Size

The median particle size is typically measured by the following “flowable particle mass based cumulative particle size distribution test” method:

This test is conducted to determine the median particle size using ASTM D 502-89, “standard test method for particle size of soaps and other detergents”, approved May 26, 1989, with a further specification for sieve sizes used in the analysis. Following section 7, “procedure using machine-sieving method,” a nest of clean dry sieves containing U.S. standard (ASTM E 11) sieves #8 (2360 um), #12 (1700 um), #16 (1180 um), #20 (850 um), #30 (600 um), #40 (425 um), #50 (300 um), #70 (212 um), #100 (150 um) is required. The prescribed machine-sieving method is used with the above sieve nest. A suitable sieve-shaking machine can be obtained from W.S. Tyler Company of Mentor, Ohio, U.S.A.

The data are plotted on a semi-log plot with the micron size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. The median particle size (D₅₀), for the purpose of this invention, is defined as the abscissa value at the point where the cumulative mass percent is equal to 50 percent, and is calculated by a straight line interpolation between the data points directly above (a50) and below (b50) the 50% value using the following equation: D₅₀=10̂[Log(Dₐ₅₀)−(Log(Dₐ₅₀)−Log(D_{b50}))*(Qₐ₅₀−50%)/(Qₐ₅₀−Q_{b50})], where Qₐ₅₀ and Q_{b50} are the cumulative mass percentile values of the data immediately above and below the 50^{th} percentile, respectively; and Dₐ₅₀ and D_{b50} are the micron sieve size values corresponding to these data.

In the event that the 50^{th} percentile value falls below the finest sieve size (150 um) or above the coarsest sieve size (2360 um), then additional sieves must be added to the nest following a geometric progression of not greater than 1.5, until the median falls between two measured sieve sizes.

The Distribution Span of the sample is a measure of the breadth of the particle size distribution about the median. It is calculated according to the following: Span=(D₈₄/D₅₀+D₅₀/D₁₆)/2, where D₅₀ is the median particle size and D₈₄ and D₁₆ are the particle sizes at the sixteenth and eighty-fourth percentiles on the cumulative mass percent retained plot, respectively. In the event that the D₁₆ value falls below the finest sieve size (150 um), then the span is calculated according to the following: Span=(D₈₄/D₅₀). In the event that the D₈₄ value falls above the coarsest sieve size (2360 um), then the span is calculated according to the following: Span=(D₅₀/D₁₆). In the event that the D₁₆ value falls below the finest sieve size (150 um) and the D₈₄ value falls above the coarsest sieve size (2360 um), then the distribution span is taken to be a maximum value of 5.7.

In addition, the 30^{th} percentile particle size (D₃₀) of the sample can also be measured. The 30^{th} percentile particle size (D₃₀) is defined as the abscissa value at the point where the cumulative mass percent is equal to 30 percent, and is calculated by a straight line interpolation between the data points directly above (a30) and below (b30) the 30% value using the following equation: D₃₀=10̂[Log(Dₐ₃₀)−(Log(Dₐ₃₀)−Log(D_{b30}))*(Qₐ₃₀−30%)/(Qₐ₃₀−Q_{b30})], where Qₐ₃₀ and Q_{b30} are the cumulative mass percentile values of the data immediately above and below the 30^{th} percentile, respectively; and Dₐ₃₀ and D_{b30} are the micron sieve size values corresponding to these data.

In the event that the 30^{th} percentile value falls below the finest sieve size (150 um), then additional sieves must be added to the nest following a geometric progression of not greater than 1.5, until the 30^{th} percentile falls between two measured sieve sizes.

### Median Aspect Ratio

The particle aspect ratio is defined as the ratio of the particle's major axis diameter (dₘₐⱼₒᵣ) relative to the particle's minor axis diameter (dₘᵢₙₒᵣ), where the major and minor axis diameters are the long and short sides of a rectangle that circumscribes a 2-dimensional image of the particle at the point of rotation where the short side of the rectangle is minimized. The 2-dimensional image is obtained using a suitable microscopy technique. For the purpose of this method, the particle area is defined to be the area of the 2-dimensional particle image.

In order to determine the aspect ratio distribution and the median particle aspect ratio, a suitable number of representative 2-dimensional particle images must be acquired and analyzed. For the purpose of this test, a minimum of 5000 particle images is required. In order to facilitate collection and image analysis of this number of particles, an automated imaging and analysis system is recommended. Such systems can be obtained from Malvern Instruments Ltd., Malvern, Worcestershire, United Kingdom; Beckman Coulter, Inc., Fullerton, Calif., USA; JM Canty, Inc., Buffalo, N.Y., USA; Retsch Technology GmbH, Haan, Germany; and Sympatec GmbH, Clausthal-Zellerfeld, Germany.

A suitable sample of particles is obtained by riffling. The sample is then processed and analyzed by the image analysis system, to provide a list of particles containing major and minor axis attributes. The aspect ratio (AR) of each particle is calculated according to the ratio of the particle's major and minor axis, AR=dₘₐⱼₒᵣ/dₘᵢₙₒᵣ.

The list of data are then sorted in ascending order of particle aspect ratio and the cumulative particle area is calculated as the running sum of particle areas in the sorted list. The particle aspect ratio is plotted against the abscissa and the cumulative particle area against the ordinate. The median particle aspect ratio (AR50) is the abscissa value at the point where the cumulative particle area is equal to 50% of the total particle area of the distribution.

### EXAMPLES

### Example 1

The particle comprises of a core, a liquid binder and a coating powder. These materials are mixed together in a series of batch mixes to create the final 1.4 mm to 2.0 mm sized aesthetic bead, as follows.

Batch 1: The core material is screened granular sodium sulphate prepared by a classification between 500 micrometer and 1000 micrometer screens. The layering powder is sodium carbonate, milled using a Retsch ZM200 to produce a milled material of <30 micrometers. The liquid binder is alkyl benzene sulphonic acid.

A mass of 200 grams of the core particles is loaded into a Kenwood FP520 Series mixer with a plastic bladed impeller and the mixer turned on to speed setting #1 to induce a centrifugal flow pattern in the mixer. A series of twenty sequential layering steps are then performed, alternately adding 2 grams of liquid binder drop-wise via a syringe, contacting the core particles in the mixer, followed by 6.9 grams of layering powder, also added through the top of the mixer, adding more binder, more layering powder, etc., until the product composition is built up in layers surrounding the core particles. 138 grams of layering powder is added in total. 40 grams of liquid binder is added into the mixer in total.

The resulting coated particle is then screened through 1400 micrometers and on 850 micrometers. 200 grams are needed for the second batch as cores. If this yield is not achieved, Batch 1 is repeated to achieve a total of 200 grams of Batch 1 coated material between 850 micrometers and 1400 micrometers.

Batch 2: The core material is Batch 1 coated material. The layering powder is sodium Carbonate, milled using a Retsch ZM200 to produce a milled material of <30 micrometers. The liquid binder is alkyl benzene sulphonic acid.

A mass of 200 g of the core particles is loaded into a Kenwood FP520 Series mixer with a plastic bladed impeller and the mixer turned on to speed setting #1 to induce a centrifugal flow pattern in the mixer. A series of eleven sequential layering steps are then performed, alternately adding 3 grams of liquid binder drop-wise via a syringe, contacting the core particles in the mixer, followed by 11.7 grams of layering powder, also added through the top of the mixer, adding more binder, more layering powder, etc., until the product composition is built up in layers surrounding the core particles. 129 grams of layering powder is added in total. 33 grams of liquid binder is added into the mixer in total.

The resulting coated particle is then screened through 1400 mircometers and on 850 micrometers. 228 grams are needed for the third batch as cores. If this yield is not achieved, Batch 1 and 2 are repeated to achieve a total of 228 grams of Batch 2 coated material between 850 micrometers and 1400 micrometers.

Batch 3: The core material is Batch 2 coated material. The layering powder is sodium Carbonate, milled using a Retsch ZM200 to produce a milled material of <30 micrometers. The liquid binder is a pre-mix for 2R Sodium Silicate Solution at 30% activity added to lexonyl Orange dye, creating the following pre-mix composition:

Liquid pre-mix 1: 2R sodium silicate—29.6% w/w, lexonyl orange dye—1.4% w/w, water—69.0% w/w

A mass of 228 g of the core particles is loaded into a Kenwood FP520 Series mixer with a plastic bladed impeller and the mixer turned on to speed setting #1 to induce a centrifugal flow pattern in the mixer. A series of ten sequential layering steps are then performed, alternately adding 5 grams of liquid binder drop-wise via a syringe, contacting the core particles in the mixer, followed by 18 grams of layering powder, also added through the top of the mixer, adding more binder, more layering powder, etc., until the product composition is built up in layers surrounding the core particles. 180 grams of layering powder is added in total. 50 grams of liquid binder is added into the mixer in total.

The resulting coated particle is then screened through 2000 micrometers and on 1400 micrometers. The resulting particle is extremely free flowing with a relative jamming onset of 5.7, has a median particle size of 1,500 micrometers, bulk density of 1,049 g/l, and extremely spherical with a median aspect ratio of 1.1.

### Batch Composition Summary (% w/w):

| Material | Batch 1 | Batch 2 | Batch 3 |
|---|---|---|---|
| Sodium Sulphate | 52.9 | 29.2 | 14.5 |
| Sodium Carbonate | 36.5 | 55.8 | 67.1 |
| alkyl benzene | 10.6 | 15.0 | 7.5 |
| sulphonic acid | | | |
| Liquid Pre-mix 1 | — | — | 10.9 |
| Total % w/w | 100.0 | 100.0 | 100.0 |

### Example 2

Example finished product formulations incorporating above aesthetic particle example:

TABLE 1
Finished Product formulations (% w/w)

| Ingredient* | (a) | (b) | (c) | (d) | (e) | (f) | (g) |
|---|---|---|---|---|---|---|---|
| 1 | 1.1 | 3.2 | 1.4 | 0.8 | 1.0 | 1.1 | 4.7 |
| 2 | 20.0 | 20.0 | 23.0 | 23.0 | 13.5 | 22.3 | 22.3 |
| 3 | 38.0 | 35.9 | 29.5 | 28.9 | 9.4 | 30.5 | 26.9 |
| 4 | 0.0 | 0.0 | 0.0 | 0.0 | 0.3 | 0.0 | 0.0 |
| 5 | 7.5 | 7.5 | 8.5 | 8.5 | 13.0 | 10.5 | 10.5 |
| 6 | 1.0 | 1.0 | 0.0 | 0.0 | 0.0 | 0.0 | 0.0 |
| 7 | 0.0 | 0.0 | 4.0 | 4.0 | 0.0 | 0.0 | 0.0 |
| 8 | 1.0 | 1.0 | 3.8 | 3.8 | 0.0 | 1.5 | 1.5 |
| 9 | 0.9 | 0.9 | 0.0 | 0.0 | 0.7 | 0.5 | 0.5 |
| 10 | 0.0 | 0.0 | 0.5 | 0.5 | 5.5 | 1.0 | 1.0 |
| 11 | 0.2 | 0.2 | 0.2 | 0.2 | 0.2 | 0.1 | 0.1 |
| 12 | 0.0 | 0.0 | 0.0 | 0.0 | 1.8 | 0.0 | 0.0 |
| 13 | 15.4 | 15.4 | 2.0 | 2.0 | 20.1 | 9.0 | 9.0 |
| 14 | 0.2 | 0.2 | 0.2 | 0.2 | 0.1 | 0.1 | 0.1 |
| 15 | 0.4 | 0.4 | 0.5 | 0.5 | 0.1 | 0.4 | 0.4 |
| 16 | 0.2 | 0.2 | 1.0 | 1.0 | 0.2 | 0.4 | 0.4 |
| 17 | 0.5 | 0.5 | 0.0 | 0.0 | 0.6 | 0.0 | 0.0 |
| 18 | 1.5 | 1.5 | 3.0 | 3.0 | 2.0 | 1.4 | 1.4 |
| 19 | 7.3 | 7.3 | 15.6 | 15.6 | 16.7 | 7.2 | 7.2 |
| 20 | 0.3 | 0.3 | 0.5 | 0.5 | 1.0 | 0.3 | 0.3 |
| 21 | 0.4 | 0.4 | 0.5 | 0.5 | 0.4 | 0.2 | 0.2 |
| 22 | 1.1 | 1.1 | 3.4 | 3.4 | 5.5 | 0.9 | 0.9 |
| 23 | 0.2 | 0.2 | 0.1 | 0.1 | 0.2 | 0.2 | 0.2 |
| 24 | 0.0 | 0.0 | 0.0 | 0.0 | 1.0 | 0.1 | 0.1 |
| 25 | 0.0 | 0.0 | 0.0 | 0.0 | 0.3 | 0.0 | 0.0 |
| 26 | 0.0 | 0.0 | 0.0 | 0.0 | 0.0 | 8.5 | 8.5 |
| 27 | 0.0 | 0.0 | 0.0 | 0.0 | 0.0 | 0.2 | 0.2 |
| 28 | 0.0 | 0.0 | 0.0 | 0.0 | 0.0 | 0.9 | 0.9 |
| 29 | 2.8 | 2.8 | 2.3 | 2.3 | 6.4 | 2.7 | 2.7 |

*Table 1 ingredient list: 1) The aesthetic particle example 1 above; 2) sodium carbonate; 3) sodium sulphate; 4) sodium silicate; 5) sodium alkyl benzene sulfonate; 6) tallow alkyl sulfate; 7) sodium alkyl ethoxysulfate; 8) sodium acrylic-maleic copolymer; 9) cationic detersive surfactant; 10) non-Ionic detersive surfactant; 11) optical brightener; 12) carboxymethyl cellulose; 13) sodium aluminosilicate, zeolite structure; 14) ethylenediamine disuccinic acid; 15) MgSO₄; 16) Hydroxyethane di(methylene phosphonic acid); 17) Soap; 18) Citric Acid; 19) Sodium percarbonate (having from 12% to 15% active AvOx); 20) Enzymes; 21) Suds suppressor agglomerate (11.5% active); 22) TAED agglomerate (92% Active TAED, 5% carboxymethyl cellulose); 23) Photobleach Particle (1% active); 24) hydrophobically modified cellulose material; 25) soil release polymer; 26) bentonite clay; 27) polyethylene oxide flocculating agent; 28) silicone oil; 29) moisture and raw material by products.

### Example 3

### Physical Features of the Compositions Detailed in Example 2

TABLE 2
Finished Product formulations (% w/w)

| Physical | | | | | | | |
|---|---|---|---|---|---|---|---|
| feature | (a) | (b) | (c) | (d) | (e) | (f) | (g) |
| ρ_{bead} | 1049 | 1049 | 1049 | 1049 | 1049 | 1049 | 1049 |
| ρ_{base} | 613 | 613 | 613 | 613 | 850 | 613 | 613 |
| ρ_{bead}/ρ_{base} | 1.71 | 1.71 | 1.71 | 1.71 | 1.23 | 1.71 | 1.71 |
| D50_{bead} | 1500 | 1500 | 1500 | 1500 | 1500 | 1500 | 1500 |
| D50_{base} | 500 | 500 | 500 | 500 | 700 | 500 | 500 |
| D50_{bead}/ | 3 | 3 | 3 | 3 | 2.14 | 3 | 3 |
| D50_{base} | | | | | | | |
| AR50_{bead} | 1.1 | 1.1 | 1.1 | 1.1 | 1.1 | 1.1 | 1.1 |
| RJO_{bead} | 5.7 | 5.7 | 5.7 | 5.7 | 5.7 | 5.7 | 5.7 |
| RJO_{base} | 27 | 27 | 27 | 27 | 18 | 27 | 27 |
| V_{bead} | 0.6% | 1.9% | 0.8% | 0.5% | 0.8% | 0.6% | 2.8% |
| V_{base} | 99.4% | 98.1% | 99.2% | 99.5% | 99.2% | 99.4% | 97.2% |
| SI | 3.77 | 3.82 | 3.77 | 3.76 | 3.72 | 3.77 | 3.85 |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid particulate laundry detergent composition comprising:
(a) from about 0.1 wt % to about 50 wt % of aesthetic particle; and
(b) to 100 wt % of the remainder of the solid particulate laundry detergent composition, wherein the ratio of the median particle size in micrometers of the aesthetic particle (D50_{bead}) to the median particle size in micrometers of the remainder of the solid particulate laundry detergent composition (D50_{base}) is greater than about 2.0:1, and wherein the relative jamming onset of the aesthetic particle (RJO_{bead}) is less than about 9.0.

2. A solid particulate laundry detergent composition according to claim 1, wherein the solid particulate laundry detergent composition comprises from about 0.3 wt % to about 8 wt % of aesthetic particle, wherein the ratio of the median particle size in micrometers of the aesthetic particle (D50_{bead}) to the median particle size in micrometers of the remainder of the solid particulate laundry detergent composition (D50_{base}) is greater than about 3.0:1, and wherein the relative jamming onset of the aesthetic particle (RJO_{bead}) is less than about 6.0.

3. A solid particulate laundry detergent composition according to claim 1, wherein the solid particulate laundry detergent composition has a segregation index (SI) of less than about 6.0,
wherein the segregation index (SI)=(RJO_{bead}/V_{base})×|ln(ρ_{bead}/ρ_{base})−ln(D50_{bead}×AR50_{bead}/D50_{base})|,
wherein RJO_{bead} is the relative jamming onset of the aesthetic particle,
wherein V_{base} is the volume fraction of the remainder of the solid particulate laundry detergent composition and=1.0−V_{bead},
wherein V_{bead} is the volume fraction of the aesthetic particle,
wherein ρ_{bead} is the bulk density in g/l of the aesthetic particle,
wherein ρ_{base} is the bulk density in g/l of the remainder of the solid particulate laundry detergent composition,
wherein D50_{bead} is the median particle size in micrometers of the aesthetic particle,
wherein D50_{base} is the median particle size in micrometers of the remainder of the solid particulate laundry detergent composition, and
wherein AR50_{bead} is the median aspect ratio of the aesthetic particle.

4. A solid particulate laundry detergent composition according to claim 1, wherein the segregation index (SI) is from about 0.01 to about 4.0.

5. A solid particulate laundry detergent composition according to claim 1, wherein D50_{bead}/D50_{base} is greater than about 2.6.

6. A solid particulate laundry detergent composition according to claim 1, wherein V_{bead} is in the range of from about 0.005 to about 0.2.

7. A solid particulate laundry detergent composition according to claim 1, wherein the aesthetic particle is visually distinct from the remainder of the solid particulate laundry detergent composition.

8. A solid particulate laundry detergent composition according to claim 1, wherein the aesthetic particle is substantially spherical in shape.

9. A solid particulate laundry detergent composition according to claim 1, wherein the aesthetic particle has a median aspect ratio of from about 1.0 to about 1.2.

10. A solid particulate laundry detergent composition according to claim 1, wherein the aesthetic particle comprises a core and an outer layer.

11. A solid particulate laundry detergent composition according to claim 1, wherein D50_{bead} is in the range of from about 800 micrometers to about 4,000 micrometers.
